(19) United States
(12) Patent Application Publication
(10) Pub. No.: US 2026/0050634 A1
(43) Pub. Date: Feb. 19, 2026

(54) METHOD, APPARATUS, AND COMPUTER-READABLE MEDIUM FOR ATTRIBUTE PROPAGATION

(71) Applicant: Kunato Inc., New York, NY (US)

(72) Inventor: Illan POREH, New York, NY (US)

(21) Appl. No.: 19/298,773

(22) Filed: Aug. 13, 2025

Related U.S. Application Data
(60) Provisional application No. 63/682,386, filed on Aug. 13, 2024.

(51) Int. Cl. G06F 16/901; G06F 18/22

(52) U.S. Cl. CPC G06F 16/9024; G06F 18/22

(57) ABSTRACT

A method, apparatus, and computer-readable medium for attribute propagation, including storing a connected graph comprising a plurality of node data structures corresponding to a plurality of content items, detecting a change in the attribute of a node data structure in the plurality of node data structures, the change in the attribute being represented by a delta value of the node data structure, designating the node data structure as a transmitter node, and propagating the change in the attribute of the node data structure to connected node data structures in the connected graph.

### RELATED APPLICATION DATA

This application claims priority to U.S. Provisional Application No. 63/682,386, filed Aug. 13, 2024, the disclosure of which is hereby incorporated by reference in its entirety.

### BACKGROUND

Items of content, such as digital content, are frequently related to one another in various ways. For example, news articles relating to a particular event are semantically related, in that they describe the same event.

Content distribution systems frequently reference large numbers of related content items, but events that impact a specific content item do not necessarily affect other related content items. For example, two similar content items can provide analysis related to a particular event. If attributes of one of those content items changes, existing content distribution system are not able to leverage those changes with respect to the other content item.

Accordingly, improvements are needed in methods and systems for attribute propagation.

### BRIEF DESCRIPTION OF DRAWINGS

FIG. 1 illustrates a flowchart for attribute propagation according to an exemplary embodiment.

FIG. 2 illustrates a diagram of the connected graph and corresponding content items according to an exemplary embodiment.

FIG. 3 illustrates the components of the connected graph according to an exemplary embodiment.

FIG. 4 illustrates a diagram of the attribute update and propagation initiation process according to an exemplary embodiment.

FIG. 5 illustrates a diagram of the new content and node addition process according to an exemplary embodiment.

FIGS. 6A-6E illustrate an example of the propagation process in the connected graph according to an exemplary embodiment.

FIG. 7 illustrates a flowchart for avoiding cyclic conflicts in the propagation process according to an exemplary embodiment.

FIGS. 8A-8D illustrate an example of avoiding cyclic conflicts in the propagation process according to an exemplary embodiment.

FIG. 9 illustrates a flowchart for performing a garbage collection process in the connected graph according to an exemplary embodiment.

FIG. 10 illustrates the components of the specialized computing environment configured to perform the processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention.

However, because such elements do not facilitate a better understanding of the invention, a description of such elements is not provided herein.

Applicant has discovered a method, apparatus, and computer-readable medium for attribute propagation that resolves existing problems in the field. The present system can be utilized in content distribution and hosting systems in order to propagate changes to attributes across different content items.

The attributes can include, for example, prices of content items or the value of digital content, such as articles, news, analysis, images, video, audiovisual content, or any other digital content. Other attributes can include, for example, reliability, popularity, accuracy, age, etc. In content distribution systems that store a real-time price for different items of content, price changes to one item of content can be propagated to related or similar items of content to trigger price changes in the similar content items.

The attribute propagation system and method disclosed herein has several advantages:
Rapid Propagation: The present propagation system ensures that attribute adjustments propagate efficiently across a content network. In the content of price attributes, the present system models price changes and can optimize the speed and reach of these adjustments, ensuring that the entire network reflects the most current values in real-time.
Alignment: The present system ensures that attributes across related content are aligned. For example, a content article may be debunked due to errors in the factual reporting in the article, resulting in a low reliability attribute. However, related content articles may not be accurately flagged as having low reliability. In the context of price attributes, the diffusion of price information can affect market dynamics, influencing user behavior and engagement with content. For example, a price increase for popular content might decrease its consumption but increase interest in similar and less expensive content. By propagating price changes, the present system ensures that the price of all similar content is aligned.
Feedback Loops: The model can help identify and manage feedback loops that result from interconnected attribute changes. In the context of price attributes, the present system ensures that the price change of one piece of content does not lead to a cascading effect that eventually cycles back and re-influences the original piece's price.

The method, apparatus, and computer-readable medium of the present application is directed to an attribute propagation model, such as a price propagation model. The attribute propagation model is a specialized information diffusion model, which is itself a sub-type of an information propagation model. The attribute propagation model spreads attribute changes based on cascade pattern. It simulates how actions or information spread in networks as a series of cascades, where each adoption can trigger further adoptions, potentially leading to viral adoption of a attribute changes.

Information propagation models understand, simulate, and predict how information spreads within and across networks. These models are useful for analyzing the dynamics of information flow among individuals, groups, or entities connected through various forms of communication channels. The primary goal of these models is to capture the mechanisms and factors that influence the dissemination and reception of information, including the speed, scale, and pattern of spread.

An information diffusion model is a specific type of information propagation model focused on understanding and predicting how information spreads through networks over time. It seeks to capture the process by which information, ideas, behaviors, or innovations are adopted and passed along from one entity to another, tracing the pathways of diffusion within a social system or network.

Information diffusion models involve several key concepts, described below:
Adoption Process: Information diffusion models often emphasize the stages through which nodes in a network go through before fully adopting an idea or piece of information. This can include initial awareness, interest development, evaluation, and finally, adoption.
Network Structure: The configuration of the network—how nodes are connected—plays a significant role in diffusion processes. Properties such as density, clustering, and the presence of highly connected nodes can greatly influence the speed and pattern of information spread.
Influencers and Innovators: Certain nodes within the network may act as influencers or innovators, playing a crucial role in initiating and propelling the diffusion process. These are typically individuals or entities with high connectivity who can reach a large number of nodes.
Thresholds: Many diffusion models incorporate the concept of thresholds, which represent the proportion of neighbors who must adopt an innovation before a given node will follow suit. This reflects the social pressure or perceived popularity necessary for adoption.

Key Elements of the Attribute Propagation Model of the Present System Are described below:
Nodes and Edges: The network is represented as graphs consisting of nodes (corresponding to content items) and edges (relationships between nodes). Each edge holds a weight based on similarity of the two nodes connected by the edge.
Mechanisms of Spread: Information is spread as diffusion (spread through a medium over time) via a cascade model. This model simulates how actions or information spreads in networks as a series of cascades, where each adoption can trigger further adoptions, potentially leading to a viral spread.
Influencing Factors: Several factors can influence the rate and extent of information spread, including the network structure (e.g., density, centrality), the strength of change (e.g., dot product of change and weightage of edge), and the attributes of the nodes (e.g., delta accumulation, thresholds and adaptive status).

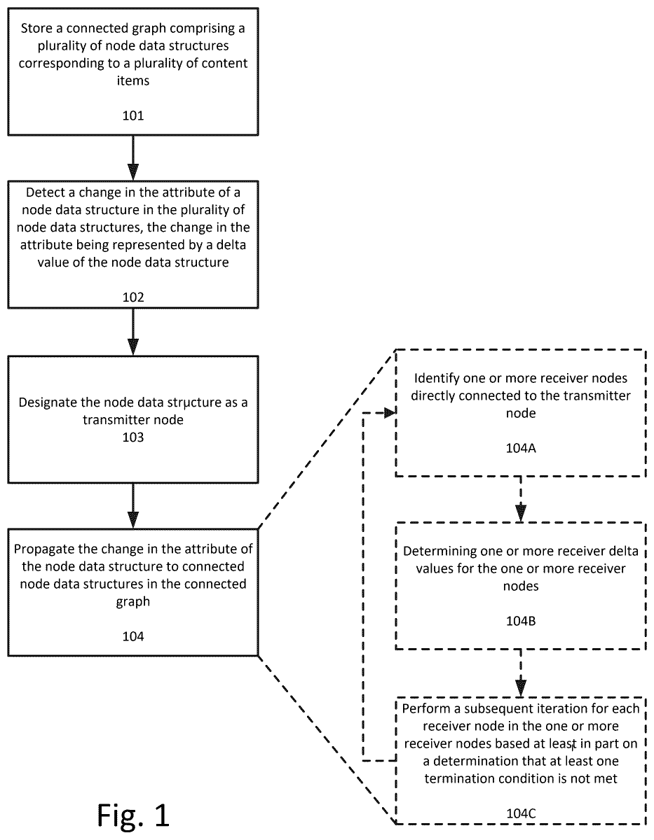

FIG. 1 illustrates a flowchart for attribute propagation according to an exemplary embodiment. The steps shown in FIG. 1 can be executed by one or more computing devices of a content distribution system, a content hosting system, a content pricing system, and/or an attribute propagation system/platform.

At step 101 a connected graph comprising a plurality of node data structures corresponding to a plurality of content items is stored. The connected graph can be maintained in-memory, minimizing the memory footprint and ensuring the real-time or near real-time propagation of changes throughout the network.

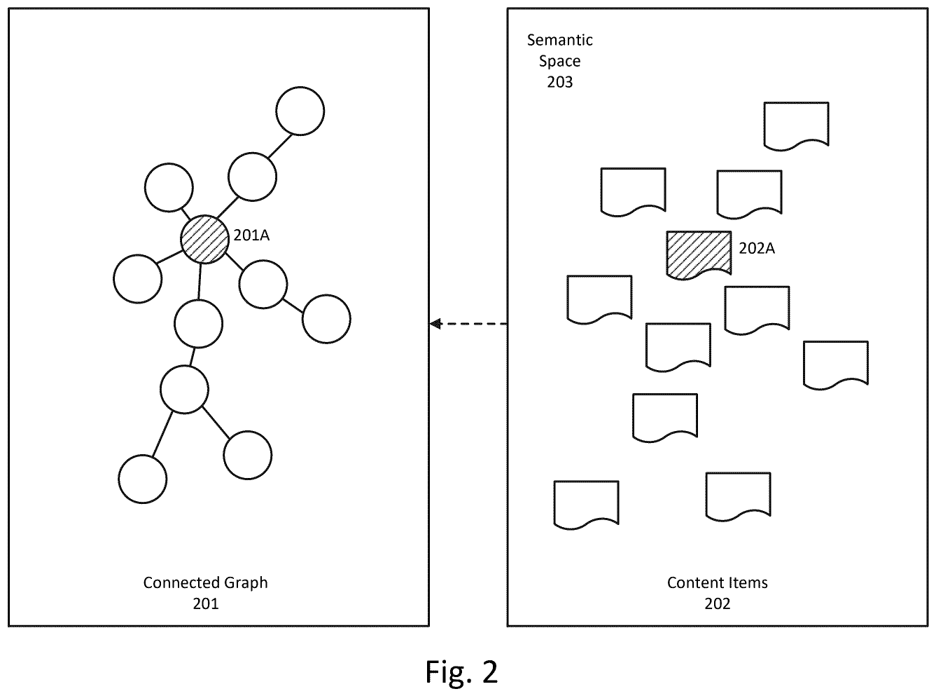

FIG. 2 illustrates a diagram of the connected graph and corresponding content items according to an exemplary embodiment. As shown in FIG. 2, the nodes of the connected graph 201 correspond to a plurality of corresponding content items 202. For example, node 201A corresponds to content item 202A. The connected graph 201 can be structured such that the nodes corresponding to more related content items are in closer proximity to one another than nodes corresponding to less related or unrelated content contents. The content items 202 are shown in semantic space 203 to illustrate the correspondence between the structure of the connected graph 201 and the semantic relationships between the content items 202. The content items 202 can be stored in a repository or database of the present system or can be stored outside the system, such as on third party systems.

The connected graph 201 can be initially generated based at least in part on semantic analysis of content items. Semantic analysis can include, for example, feature extraction and vectorization of the content items to project content item vectors in a multidimensional vector space. A semantic distance can be determined between the content items in the vector space and used to determine the structure, positioning, and linkage between corresponding nodes in the connected graph 201.

After initial generation of the connected graph 201, new nodes can be inserted into the connected graph when new content items are identified, ingested, and/or analyzed. The position and linkage of new nodes can be based on semantic analysis of the new content items and semantic similarity to content items corresponding to existing nodes.

Each node data structure in the plurality of node data structures of the connected graph can include an identifier, a plurality of neighbor pointers linking to a plurality of neighbor node data structures, and a delta value corresponding to a change in an attribute of a corresponding content item. Each neighbor pointer embeds a similarity value between a content item corresponding to the node data structure and a neighbor content item corresponding to the neighbor node data structure linked by the neighbor pointer.

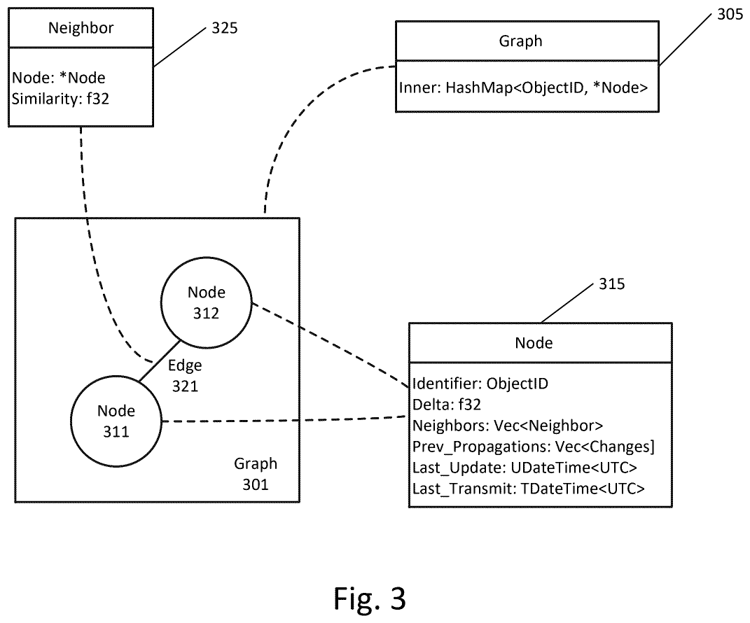

FIG. 3 illustrates the components of the connected graph according to an exemplary embodiment. A simple version of connected graph 301 is shown in FIG. 3 in order to explain the various components that make up the connected graph. Each of these components are described below in greater detail.

Graph data structure 305 corresponds to the connected graph 301. The graph data structure 305 can store millions of nodes. To locate a node by its unique identifier (unique ID), the graph data structure represented the connected graph 301 as a HashMap, where the key is the unique ID and the returned value is a pointer to the memory address of the node. The HashMap allows the present system to locate any node in constant time without the need to traverse the graph with costly DFS (Depth First Search) or BFS (Breadth First Search) algorithms.

Each node, such as nodes 311 and 312, is represented by a node data structure 315. The node data structure 315 can be represented as a struct data type of data points leaked into memory and accessible behind a pointer. The node data structure 315 can include the following data:
Identifier: This is a unique identifier for each node and can be populated with an object ID corresponding to the content item represented by the node in a database.
Delta: This is the accumulative directional delta change to particular attribute (such as price) stored in memory, such as +3.5 or −0.6, etc. The delta can be expressed a percentage change to the attribute.
Neighbors: This is a vector (array) of edges from the node, each edge represented by a neighbor data structure 325. The neighbor data structure 325 corresponds to edges in the connected graph 301, such as edge 321. Each neighbor data structure 325 is a unidirectional connection to connecting nodes with an edge weight in form of contextual similarity. Specifically, each neighbor data structure 325 stores a pointer to a connecting node (i.e., the memory address of the connecting node) and a floating point number (in this example a 32-bit floating point number) representing a similarity between a node data structure 315 and the connected node data structure referenced by the neighbor data structure 325.
Previous Propagations: The node data structure 315 can also store information on previously applied propagations in a sliding window, such as a predetermined period of time. The previous propagation information can be utilized for garbage collection purposes as discuss further below.
Last Update Time: The node data structure 315 can further store a timestamp when the node last received a trigger signal or a propagation of changes. The trigger signal corresponds to an update or change in an attribute of the content item corresponding to the node data structure 315. The last update time can also be used for garbage collection purposes.
Last Transmit Time: The node data structure 315 can further store an optional timestamp when the node last triggered a propagation in the network. The presence of this value can also categorize a node as a transmitter.
Transmitter/Receiver Flag: Optionally, the node data structure 315 can include transmitter and/or receiver flags identifying the corresponding node as a transmitter and/or a receiver. The transmitter and receiver labels are utilized during the attribute propagation process. The flags can be, for example, Boolean variables set to either true or false.

Returning to FIG. 1, at step 102 a change in the attribute of a node data structure in the plurality of node data structures is detected, the change in the attribute being represented by a delta value of the node data structure. At step 103, the node data structure for which the change was detected is designated as a transmitter node. As discussed below, the transmitted node role is utilized in the propagation process.

The step of detecting a change in the attribute of a node data structure in the plurality of node data structures can include receiving an update corresponding to the node data structure from one or more models configured to compute the attribute for a content item corresponding to the node data structure, the update being received via a webhook Application Programming Interface (API).

For example, when the attribute is a content price, one or more pricing models can compute a change in price for a content item and communicate that change in price to the propagation system via a webhook API. The one or more pricing models can include various types of pricing models, referred to as large pricing models. The pricing models can include quantitative models, quantitative market value models, and/or analytics or transaction based models. For example, a pricing model can analyze metrics relating to a content item, such as accesses, requests, downloads, traffic, etc., and compute a change in price for that content item and then communicate that change in price to the propagation system.

The connected graph is a dynamic data structure that evolves in real-time. As the attribute determination models (such as large pricing models) process new information, the graph expands to incorporate these fresh nodes. To support these dynamic updates, the propagation service of the present system can include a web application that includes two webhook APIs. These APIs can adapt the graph to the continuous influx of new data. The first webhook API can enable the graph to update dynamically as new content is processed. The second webhook API can be configured to receive a propagation trigger (i.e., a change in attribute value for the content necessitating a propagation to related content items) from an adaptive attribute determination model (such as an adaptive large pricing model). After receiving a request through this webhook, a propagation process can be initiated across the network.

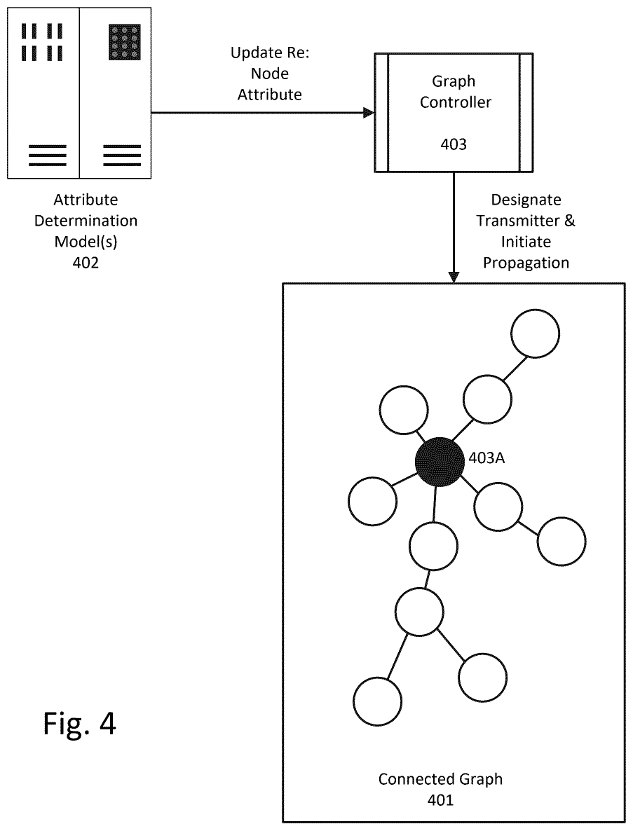

FIG. 4 illustrates a diagram of the attribute update and propagation initiation process according to an exemplary embodiment. As shown in FIG. 4, attribute determination model(s) 402 provide an update regarding a node attribute (i.e., an update regarding an attribute of the corresponding content item, such as price) to the graph controller 403. The attribute determination model can be, for example, an adaptive pricing model configured to dynamically determine a change in the price or value of a content item. As discussed above, this update can be received via a webhook API through a web application and then routed to the graph controller 403. The graph controller 403 then designates the corresponding node data structure as a transmitter node and initiates the propagation process, discussed in greater detail below.

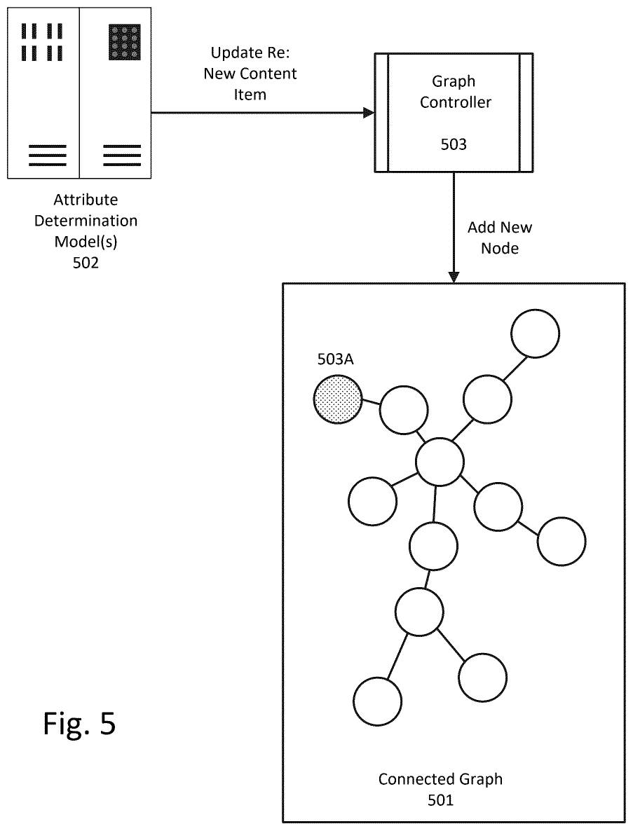

FIG. 5 illustrates a diagram of the new content and node addition process according to an exemplary embodiment. As shown in FIG. 5, attribute determination model(s) 502 provide an update regarding a new content item (i.e., an update regarding the attributes of a new content item, such as price) to the graph controller 503. The attribute determination model can be, for example, an quantitative market value pricing model configured to determine a price for a content item based on the transactions, requests, purchases, traffic, or other metrics relating to the content item. This update can also be received via a webhook API through a web application and then routed to the graph controller 503. Separate webhook APIs can be used for attribute changes, shown in FIG. 4, and for attribute determinations for new content, as shown in FIG. 5. After receiving the update/attribute information regarding the new content item, the graph controller 503 can generate a new node data structure and add the new node to the connected graph 501. As shown in FIG. 5, node 503A is added to the connected graph 501 by graph controller 503 after receiving the update regarding the new content item.

Returning to the propagation process shown in FIG. 1, at step 104, the change in the attribute of the node data structure is propagated to connected node data structures in the connected graph. As discussed previously, the initiation of propagation can be triggered by a request to an adaptive webhook. Upon receiving this trigger, the relevant node is designated as a transmitter node, beginning the dissemination of changes to its neighboring nodes.

In the graph, nodes can be classified as transmitters or receivers. Optionally, upon graph initialization, all nodes can designated as receivers. A can node transitions to a transmitter status once it receives a signal from an adaptive attribute determination model, subsequently propagating this change to its neighboring nodes. The adaptive model can takes precedence over the propagation model, ensuring that a transmitter node will ignore any subsequent propagations received from other nodes, preventing further cascading and conflicting behavior. The designation of a node as a transmitter is not fixed; it can diminishe over time, allowing for dynamic changes in the graph's structure.

The step of propagating the change in the attribute can be performed over one or more iterations of steps 104A, 104B, and 104C. Prior to the first iteration, in step 103 of FIG. 1, the relevant node data structure (for which an update in an attribute is detected/received) is designated as a transmitter node.

At step 104A one or more receiver nodes directly connected to the transmitter node are identified. The one or more receiver nodes correspond to one or more one node data structures linked to the transmitter node via one or more neighbor pointers of the transmitter node. In other words, the nodes linked to the transmitter node in the connected graph are identified as receiver nodes.

At step 104B one or more receiver delta values for the one or more receiver nodes are determined based at least in part on a transmitter delta value of the transmitter node and one or more similarity values embedded in the one or more neighbor pointers. Each receiver delta value for each receiver node can be determined as a dot product of the transmitter delta value and a similarity value embedded in a neighbor pointer linking the transmitter node to that receiver node. For instance, if an adaptive pricing model increases the price of an item of content by +10% (i.e., a delta value of 0.1), a connected node with an 80% similarity (i.e., a neighbor pointer having a 0.8 similarity value) would undergo an +8% (0.1×0.8) update. This target node would then continue the propagation process to its own neighbors in subsequent iterations, using the +8% change as the basis for further updates. Optionally, receiver delta values can also be determined based at least in part on a decay rate associated with the initial change and initiation of propagation. Over time, the impact of attribute changes can dampen, such that the more time that passes, the less of an effect the delta value of the original attribute change impacts other nodes. The decay rate can be based on a current time relative to an initial propagation time, along with one or more weightings which reduce the impact of the delta value at predetermined intervals.

When a node is connected to two transmitter nodes within a network, it faces the potential of receiving multiple propagations simultaneously. This situation can lead to the node's change being an aggregate of the propagations from both transmitters. To resolve this problem, only the difference of two changes or the average can be applied. For example: if a propagation +5 is applied and a +3 propagation arrive right afterwards, the small propagation can either be ignored or an average of 5 and 3 (which is 4) can be applied.

At step 104C subsequent iteration(s) of the one or more iterations are performed for each receiver node in the one or more receiver nodes based at least in part on a determination that at least one termination condition is not met, the subsequent iteration designating the receiver node (of the prior iteration) as the transmitter node.

The termination conditions can include one or more termination conditions for ending the propagation sequence. The one or more termination conditions can include a predetermined period of time passing since detection of the change in the attribute of the node data structure, a predetermined quantity of iterations being performed, the transmitter delta value falling below a predetermined threshold, and/or a determination that there are no receiver nodes directly connected to the transmitter node. For example, if the transmitter delta value falls under a threshold, such as 0.001%, then the system can terminate the propagation process, as the impact of this delta value on neighboring nodes is minimal. Similarly, the propagation process can terminate after a predetermined number of iterations, such as 4 iterations, terminate after a certain number of minutes, or terminate when there are no longer any neighbor/receiver nodes connected to the transmitter node that have not already been traversed. Detection of any one of the termination conditions can terminate the propagation process.

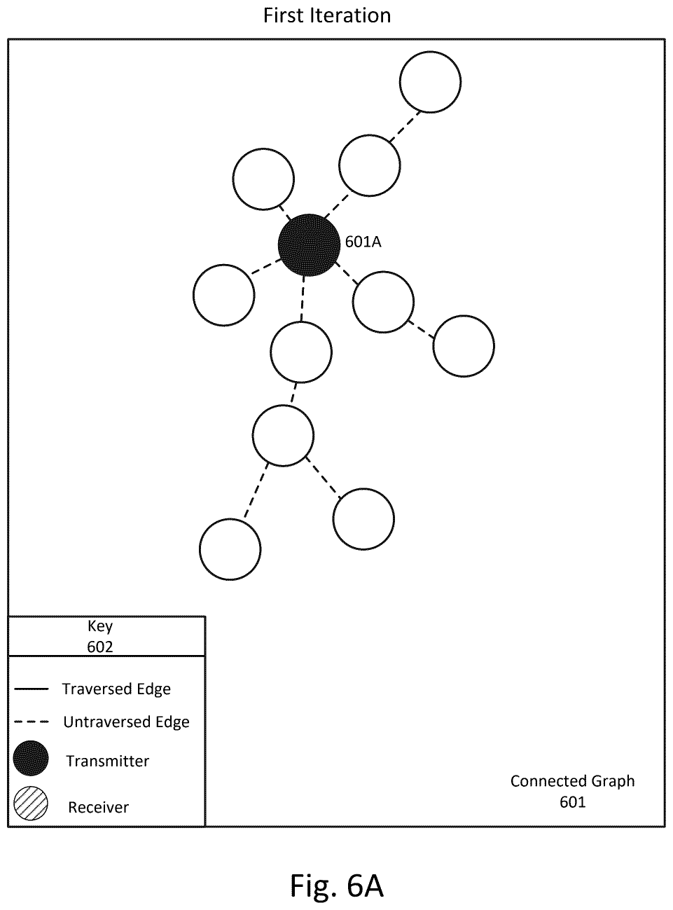

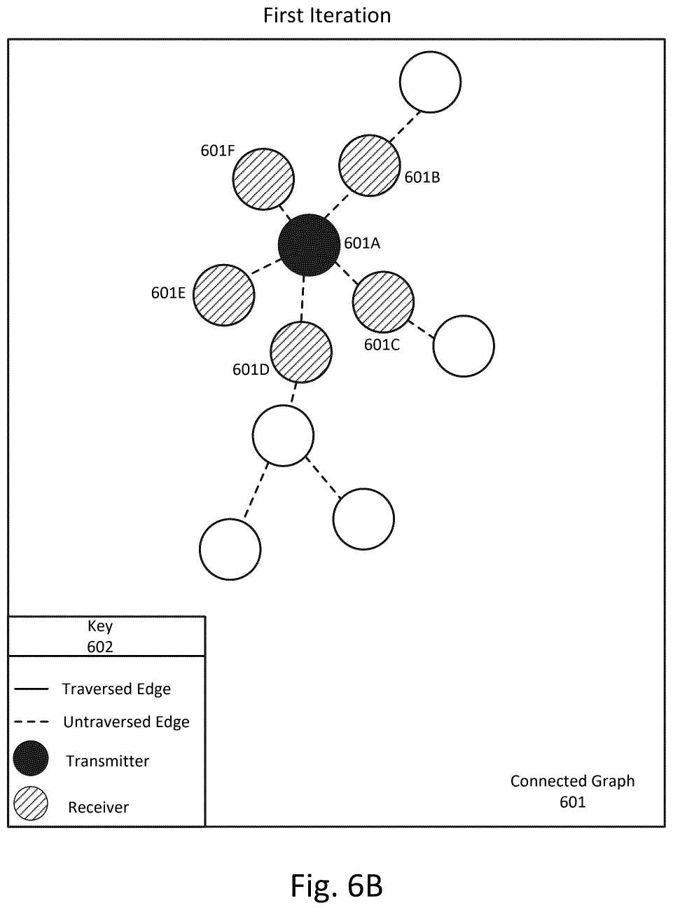

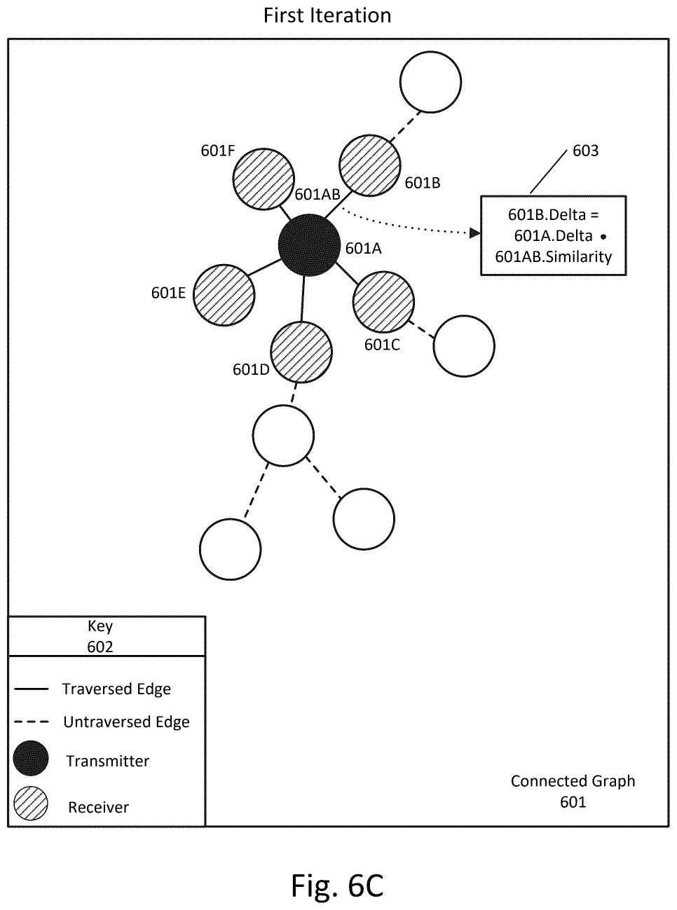

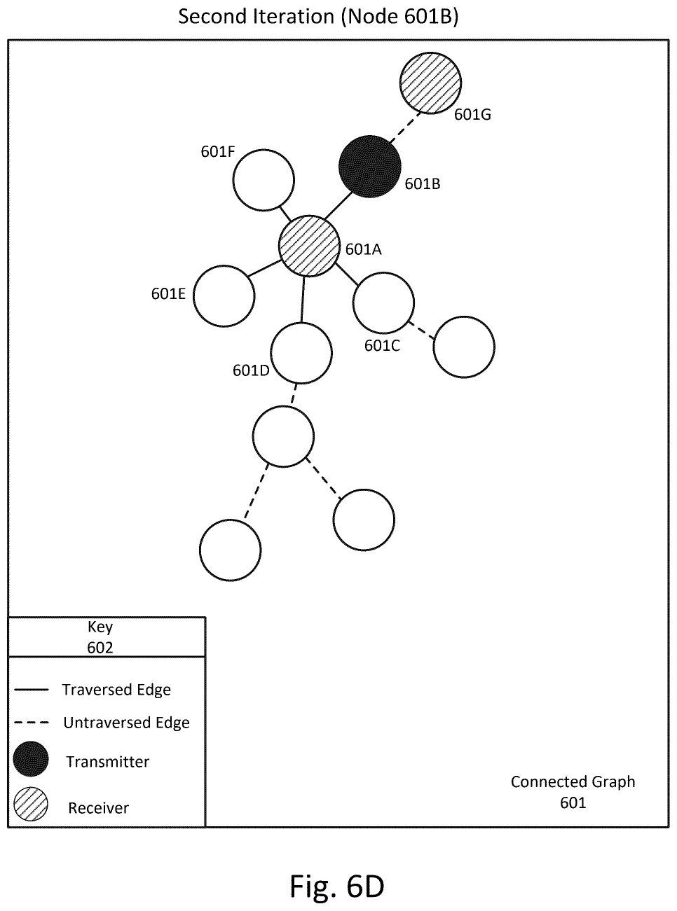

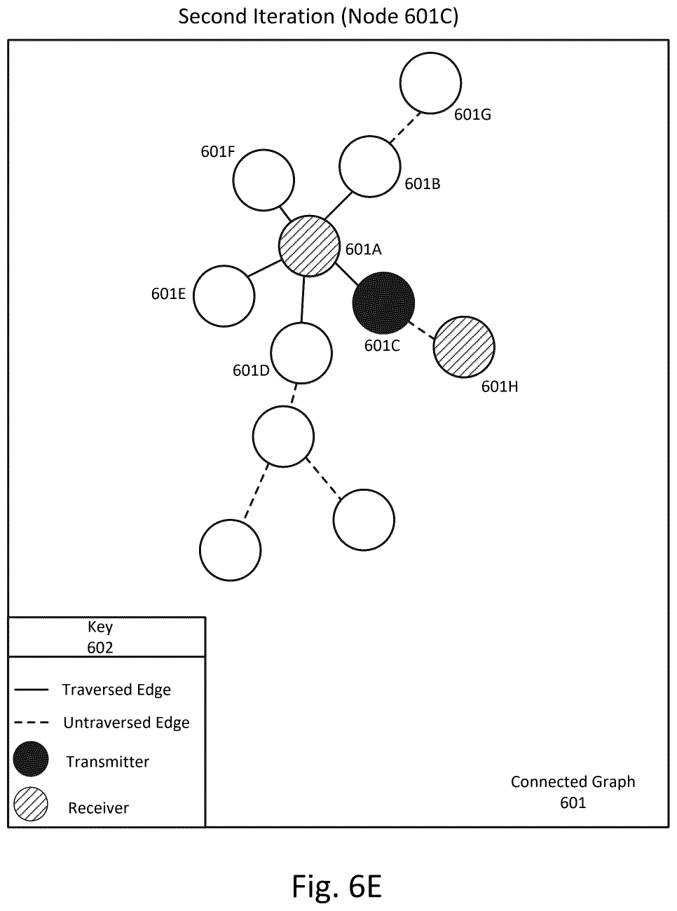

FIGS. 6A-6E illustrate an example of the propagation process in the connected graph according to an exemplary embodiment.

FIG. 6A illustrates a connected graph 601 including a plurality of nodes (i.e., node data structures corresponding to content items). FIG. 6A also includes key 602 for explanation, showing icons for nodes identified as transmitter nodes and neighbor nodes, as well traversed and untraversed edges. As shown in FIG. 6A, at the beginning of the first iteration of the propagation process, node 601A is identified as a transmitter node.

FIG. 6B illustrates the identification of receiver nodes directly linked to transmitter node 601A, including nodes 601B, 601C, 601D, 601E, and 601F.

FIG. 6C illustrates the traversal of the edges between the transmitter node and receiver nodes to compute delta values for each of the receiver nodes. As an example of this computation, box 603 illustrates the computation of the delta value for receiver node 601B. The delta value for receiver node 601B is given by the dot product of the delta value of node 601A and the similarity value of edge (neighbor pointer) 601AB.

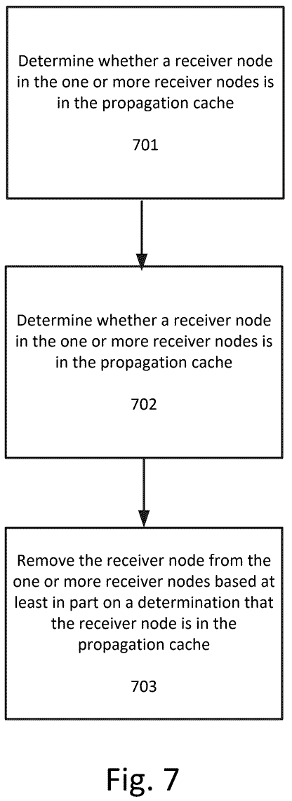

Since subsequent iterations of the propagation process are performed for each receiver node, the subsequent iterations can fork into multiple branches when there are multiple receiver nodes. FIG. 6D illustrates the second iteration of propagation with respect to Node 601B. In this iteration, Node 601B is designated at the transmitter node and nodes 601A and 601G are designated as receivers. Of course, since node 601A has already been traversed, it will not be updated again. The process for identifying previously traversed nodes and removing them from future propagation is described with respect to FIG. 7. This iteration will proceed similarly to the first iteration and the steps corresponding to this iteration are omitted here, for brevity.

FIG. 6E illustrates the second iteration of propagation with respect to Node 601C. In this iteration, Node 601C is designated at the transmitter node and nodes 601A and 601H are designated as receivers. Again, since node 601A has already been traversed, it will not be updated again. As shown by FIGS. 6D-6E, the second iteration of propagation can be performed multiple times, each instance corresponding to one of the receiver nodes in the prior (first) iteration. Specifically, the second iteration can be performed for nodes 601B, 601C, 601D, 601E, and 601F. Propagation will continue until at least one of the termination conditions is met.

As discussed with respect to FIGS. 6D-6E, the system can be configured to avoid re-traversing nodes that have already been traversed during a propagation event (i.e., a propagation triggered by a change in an attribute value from one of the attribute determination models).

FIG. 7 illustrates a flowchart for avoiding cyclic conflicts in the propagation process according to an exemplary embodiment. Given the highly interconnected nature of the nodes within the graph structure, a single propagation may traverse the same path multiple times, leading to potential cyclic conflicts. To mitigate these issues, each propagation event can be assigned a unique ID, and the nodes and/or system can maintain a cache of previously received propagations over a defined time window. This setup allows nodes to identify and discard any duplicate propagation attempts, ensuring the integrity of the propagation process.

At step 701 a propagation cache is maintained that is configured to store a list of all node data structures visited during a propagation event corresponding to a change in an attribute. The propagation cache can maintained by the system and/or by one or more of the nodes in the connected graph and can be reset at the end of every propagation event.

Steps 702-703 can be performed as part of the propagation process. Specifically, steps 702-703 can be performed at each iteration of the one or more iterations of propagation process. At step 702 it is determined whether a receiver node in the one or more receiver nodes is in the propagation cache. At step 703 the receiver node is removed from the list of one or more receiver nodes based at least in part on a determination that the receiver node is in the propagation cache.

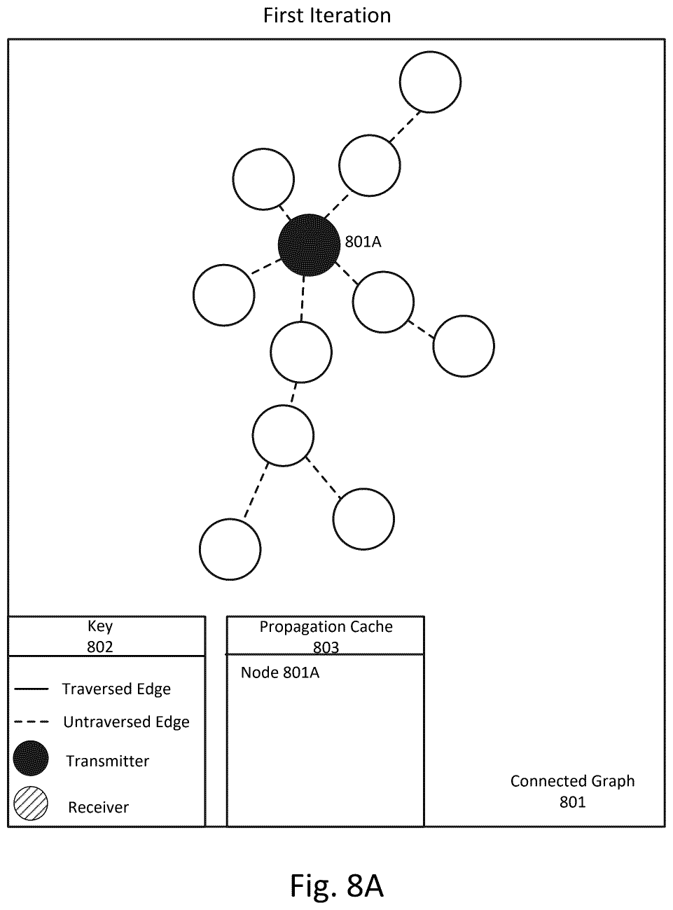

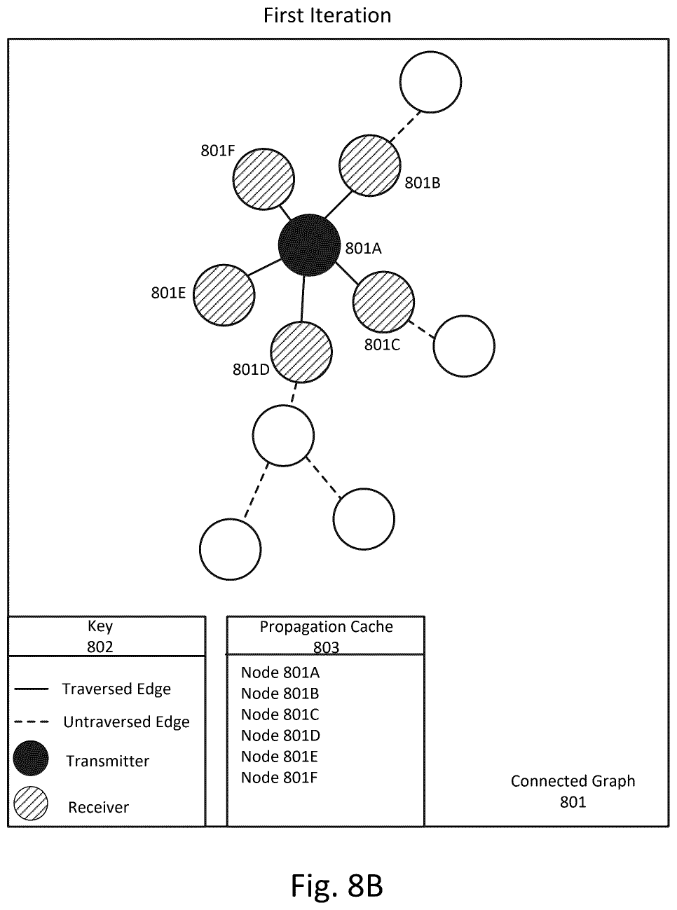

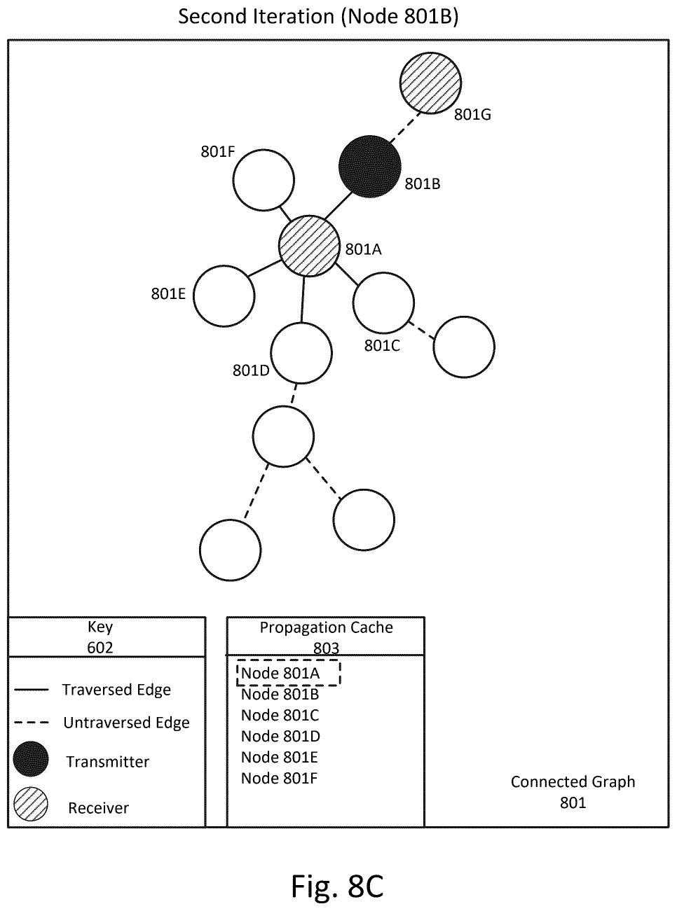

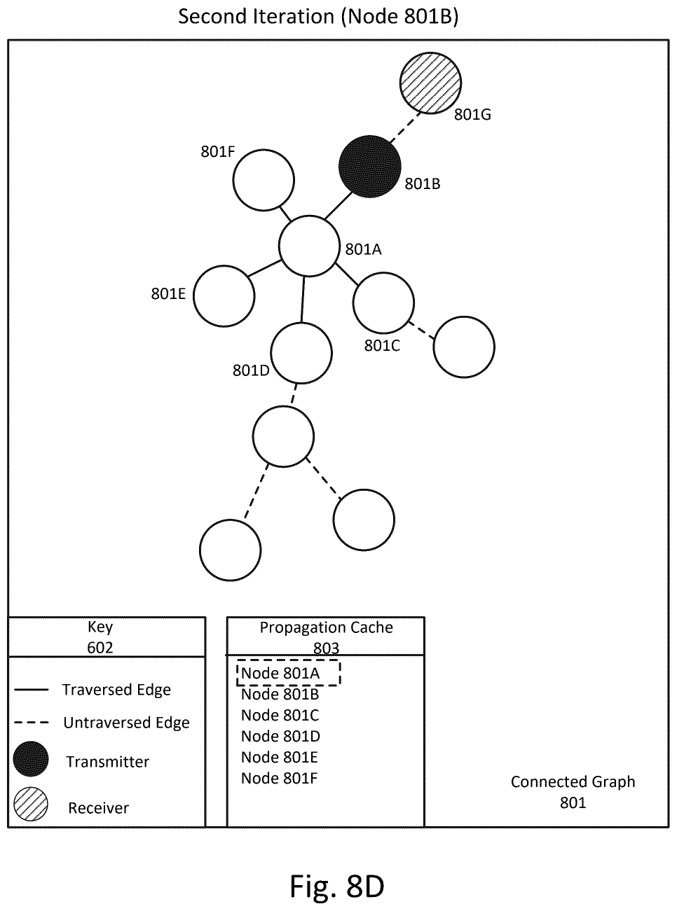

FIGS. 8A-8D illustrate an example of avoiding cyclic conflicts in the propagation process according to an exemplary embodiment. The example shown in these figures utilizing a propagation cache to avoid re-traversing previously traversed nodes.

As shown in FIG. 8A, in the first iteration of propagation process, node 801A in connected graph 801 is identified a transmitter node, as indicated by key 802. Since node 801A is the first node in the propagation process (i.e., the node that received the update to the attribute), this node is added to the propagation cache 803.

FIG. 8B illustrates the traversal of receiver nodes 801B, 801C, 801D, 801E, and 801F. All of these nodes are added to the propagation cache 803.

FIG. 8C illustrates the second iteration for node 801B. Since nodes 801A and 801G are neighboring nodes, they are initially identified as receiver nodes. However, the propagation cache 803 includes an entry for node 801A. Therefore, this node is removed as a receiver node, as shown in FIG. 8D.

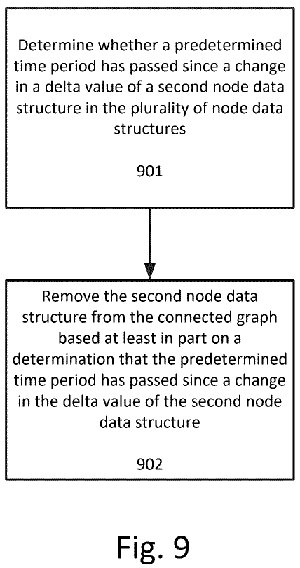

FIG. 9 illustrates a flowchart for performing a garbage collection process in the connected graph according to an exemplary embodiment. The garbage collection process removes stale nodes from the connected graph.

At step 901 it is determined whether a predetermined time period has passed since a change in a delta value of a second node data structure in the plurality of node data structures. The change in delta value can include changes resulting from propagation via other nodes, as well as changes due to attribute determination models updating attribute values of corresponding content. This step determines the period of time that has passed since the delta value of the node has changed. In the price context, this step determines when the content item corresponding to the node last changed in price and whether the price has remained static for a predetermined period of time.

At step 902 the second node data structure is removed from the connected graph based at least in part on a determination that the predetermined time period has passed since a change in the delta value of the second node data structure. This step removes nodes from the connected graph that have gone stale (i.e., that have not had a change in attribute/price in a lengthy period of time). Note that this step does not necessitate removal or deletion of the content itself, but if the attributes relating to the content (such as price) are static, then there is no need to track the content attributed in the connected graph of the propagation system.

The content ingestion systems coupled to the propagation system disclosed herein can process numerous articles every second, leading to a continuous and gradual increase in the connected graph's size. Without proper management, this unchecked growth can eventually consume all available server memory, potentially causing the operating system to terminate the process. Moreover, an excessively large data structure could significantly impair performance. To address this, the garbage collection mechanism actively scans for and removes stale nodes to ensure efficient memory management, as discussed above. Nodes that have not received a propagation or trigger within a specified time frame are considered stale and are subsequently purged from the graph. Additionally, to maintain optimal memory usage, an alert system can be configured to notify administrators when memory consumption surpasses a predefined threshold.

The attribute propagation system includes a variety of configurable properties designed to fine-tune the system's performance and efficiency in data propagation. For the service to function at its optimal level, certain properties necessitate a harmonized approach, ensuring that adjustments to one setting are appropriately reflected across others for cohesive operation. These synchronized properties play a critical role in the dynamics of data flow and include:
Transmitter Duration Limit: This Configuration Establishes the upper limit for how long a node can operate as a transmitter without acquiring new triggers. Transitioning an outdated transmitter back to a receiver status is essential for maintaining an uninterrupted and efficient propagation flow throughout the network. This mechanism ensures that only current and relevant data circulates, preventing stale information from congesting the system.
Propagation Decay Rate: This setting defines the decay of the change to an attribute. When the attribute is price, it defines the decay over the current PPC (Price Propagation Curve). The strength of the change is highest at the time of propagation and decays to zero over time. This configuration controls the decay rate
Previous Propagations Cache Duration: To avoid redundant data flows and cyclic conflicts, the system caches records of past propagations. The duration of this cache is key to balancing the freshness of data with the system's resilience to repetitive triggers.

Additionally, the attribute propagation system includes the following independent settings that can be configured according to different use-cases:
Node Inactivity Threshold: This setting specifies the length of time a node can remain inactive before it is considered for removal from the graph. It helps maintain an efficient and relevant data structure by purging nodes that no longer contribute to the network's current state.
Minimum Cumulative Delta for Propagation: to Ensure That Only significant changes are propagated through the network, this setting defines the smallest total change that warrants a database update event. It helps in reducing noise and focusing resources on meaningful data updates.
Propagation Threshold to Neighboring Nodes: This parameter sets the minimum change necessary for an update to be passed on to neighboring nodes. It dictates the threshold at which the diminishing effects of propagation no longer warrant further dissemination due to its negligible contribution to the network's value. By doing so, it preserves network resources and focuses efforts on changes with meaningful impact

By incorporating these settings, propagation system disclosed herein can efficiently handle the complexities of dynamic data propagation within a vast network. The synchronization of certain properties ensures that the system's core mechanisms operate harmoniously, while independent settings provide the flexibility needed to adapt to a range of operational scenarios.

The attribute propagation system includes several memory management features to optimize memory usage and efficiency in high volume and high traffic deployments. These include:
Horizontal Scalability: with increasing data ingestion, the memory capacity of a single server will not be able accommodate all active nodes. Accordingly, a dedicated cluster equipped with sharding and replication techniques can be used to manage the graph's storage needs. This approach enables efficient distribution and redundancy of data across multiple servers. The graph controller can interact with this storage cluster, querying it to fetch nodes as needed, ensuring the system remains scalable and responsive as it grows.
Retention Policy under heavy load: a LFU (Least Frequently Used) caching strategy can be implemented, either as a standalone solution or in conjunction with the previously mentioned cluster storage strategy, to help maintain memory usage within permissible limits. LFU operates by tracking the frequency of access for each node and prioritizing the retention of those most frequently accessed. Less frequently used nodes are identified as candidates for eviction when the system needs to free up memory. This approach ensures that the cache optimally retains the most relevant and valuable data, thereby enhancing the efficiency of memory utilization.
Recovering from crashes: an unexpected system crash, triggered by higher memory usage, a bug or a network event (for example, the Kubernetes controller relocating a pod to a different node), can lead to the loss of data stored in memory due to the process being shut down at the OS level. To safeguard against such data loss, a Write-Ahead Log (WAL) can be implemented. This feature meticulously logs the data inflow and outflow within the graph. The Inward WAL records data related to the initiation of new propagation events via the Adaptive model, while the Outward WAL documents the propagations that have been applied at the database level. In the event of a crash, the graph's state can be restored by reprocessing the changes logged in the Inward WAL and disregarding the propagations already executed, as recorded in the Outward WAL. This mechanism ensures data integrity and continuity, enabling the system to recover swiftly and accurately from unforeseen disruptions.
Aggregation & Thresholds: To enhance performance and minimize noise, the system employs various thresholds. A critical threshold is the cumulative delta change required to update the delta values in the database and connected graph. Instead of processing numerous minor updates, the system can consolidate these into a single, more substantial update, thereby necessitating only one database query to implement the change. For instance, rather than executing 20 incremental changes of 0.001% each, the system can apply a single adjustment of 0.02% if this meets the minimum update threshold. Additional thresholds determine the smallest change necessary for propagation to connected nodes, the time limit for transmitter status decay in the event of node inactivity, the rate of propagation change decay, and the cache duration for previous propagations.
Cluster-based propagation: for large data set, the nodes can be replaced with clusters of nodes (corresponding to similar content item) and the process can performed based on links between the clusters of nodes. In this case, similarity can be stored at the cluster level and delta value changes can be applied at the cluster level (i.e., to all nodes within a cluster).

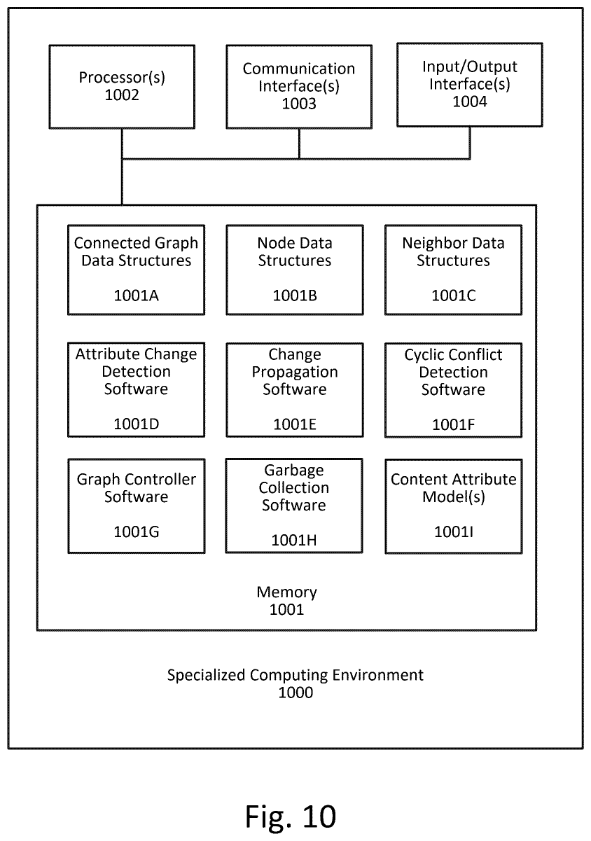

FIG. 10 illustrates the components of the specialized computing environment configured to perform the processes described herein. Specialized computing environment 1000 is a computing device that includes a memory 1001 that is a non-transitory computer-readable medium and can be volatile memory (e.g., registers, cache, RAM), non-volatile memory (e.g., ROM, EEPROM, flash memory, etc.), or some combination of the two.

As shown in FIG. 10, memory 1001 can include connected graph data structures 1001A, node data structures 1001B, neighbor data structures 1001C, attribute change detection software 1001D, change propagation software 1001E, cyclic conflict detection software 1001F, graph controller software 1001G, garbage collection software 1001H, content attribute model 1001I, and other data structures and software described herein. Each of the software components in memory 1001 store specialized instructions and data structures configured to perform the corresponding functionality and techniques described herein.

All of the software stored within memory 1001 can be stored as a computer-readable instructions, that when executed by one or more processors 1002, cause the processors to perform the functionality described with respect to FIGS. 1-9.

Processor(s) 1002 execute computer-executable instructions and can be real or virtual processors. In a multi-processing system, multiple processors or multicore processors can be used to execute computer-executable instructions to increase processing power and/or to execute certain software in parallel.

Specialized computing environment 1000 additionally includes a communication interface 1003, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1000 further includes input and output interfaces 1004 that allow users (such as system administrators) to provide input to the system to set parameters, to edit data stored in memory 1001, or to perform other administrative functions.

An interconnection mechanism (shown as a solid line in FIG. 10), such as a bus, controller, or network interconnects the components of the specialized computing environment 1000.

Input and output interfaces 1004 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1000.

Specialized computing environment 1000 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 1000.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure as defined by the appended claims.

1. A method executed by one or more computing devices for attribute propagation, the method comprising:
storing, by at least one of the one or more computing devices, a connected graph comprising a plurality of node data structures corresponding to a plurality of content items, each node data structure comprising an identifier, a plurality of neighbor pointers linking to a plurality of neighbor node data structures, and a delta value corresponding to a change in an attribute of a corresponding content item, wherein each neighbor pointer embeds a similarity value between a content item corresponding to the node data structure and a neighbor content item corresponding to the neighbor node data structure linked by the neighbor pointer;
detecting, by at least one of the one or more computing devices, a change in the attribute of a node data structure in the plurality of node data structures, the change in the attribute being represented by a delta value of the node data structure;
designating, by at least one of the one or more computing devices, the node data structure as a transmitter node; and
propagating, by at least one of the one or more computing devices, the change in the attribute of the node data structure to connected node data structures in the connected graph, wherein propagating the change in the attribute comprises performing one or more iterations of:
identifying one or more receiver nodes directly connected to the transmitter node, the one or more receiver nodes corresponding to one or more one node data structures linked to the transmitter node via one or more neighbor pointers of the transmitter node;
determining one or more receiver delta values for the one or more receiver nodes based at least in part on a transmitter delta value of the transmitter node and one or more similarity values embedded in the one or more neighbor pointers; and
performing a subsequent iteration of the one or more iterations for each receiver node in the one or more receiver nodes based at least in part on a determination that at least one termination condition is not met, wherein the subsequent iteration designates the receiver node as the transmitter node.

2. The method of claim 1, wherein detecting a change in the attribute of a node data structure in the plurality of node data structures comprises:
receiving an update corresponding to the node data structure from a model configured to compute the attribute for a content item corresponding to the node data structure, the update being received via a webhook Application Programming Interface (API).

3. The method of claim 1, wherein each receiver delta value for each receiver node is determined as a dot product of the transmitter delta value and a similarity value embedded in a neighbor pointer linking the transmitter node to that receiver node.

4. The method of claim 1, further comprising:
maintaining, by at least one of the one or more computing devices, a propagation cache configured to store a list of all node data structures visited during a propagation event corresponding to a change in an attribute.

5. The method of claim 4, wherein each iteration in the one or more iterations further comprises:
determining whether a receiver node in the one or more receiver nodes is in the propagation cache; and
removing the receiver node from the one or more receiver nodes based at least in part on a determination that the receiver node is in the propagation cache.

6. The method of claim 1, wherein the at least one termination condition comprises one or more of:
a predetermined time period passing since detection of the change in the attribute of the node data structure;
a predetermined quantity of iterations being performed;
the transmitter delta value falling below a predetermined threshold; or
a determination that there are no receiver nodes directly connected to the transmitter node.

7. The method of claim 1, further comprising:
determining, by at least one of the one or more computing devices, whether a predetermined time period has passed since a change in a delta value of a second node data structure in the plurality of node data structures; and
removing, by at least one of the one or more computing devices, the second node data structure from the connected graph based at least in part on a determination that the predetermined time period has passed since a change in the delta value of the second node data structure.

8. An apparatus executed by one or more computing devices for attribute propagation, the apparatus comprising:
one or more processors; and
one or more memories operatively coupled to at least one of the one or more processors and having instructions stored thereon that, when executed by at least one of the one or more processors, cause at least one of the one or more processors to:
store a connected graph comprising a plurality of node data structures corresponding to a plurality of content items, each node data structure comprising an identifier, a plurality of neighbor pointers linking to a plurality of neighbor node data structures, and a delta value corresponding to a change in an attribute of a corresponding content item, wherein each neighbor pointer embeds a similarity value between a content item corresponding to the node data structure and a neighbor content item corresponding to the neighbor node data structure linked by the neighbor pointer;
detect a change in the attribute of a node data structure in the plurality of node data structures, the change in the attribute being represented by a delta value of the node data structure;
designate the node data structure as a transmitter node; and
propagate the change in the attribute of the node data structure to connected node data structures in the connected graph, wherein propagating the change in the attribute comprises performing one or more iterations of:
identifying one or more receiver nodes directly connected to the transmitter node, the one or more receiver nodes corresponding to one or more one node data structures linked to the transmitter node via one or more neighbor pointers of the transmitter node;
determining one or more receiver delta values for the one or more receiver nodes based at least in part on a transmitter delta value of the transmitter node and one or more similarity values embedded in the one or more neighbor pointers; and
performing a subsequent iteration of the one or more iterations for each receiver node in the one or more receiver nodes based at least in part on a determination that at least one termination condition is not met, wherein the subsequent iteration designates the receiver node as the transmitter node.

9. The apparatus of claim 8, wherein the instructions that, when executed by at least one of the one or more processors, cause at least one of the one or more processors to detect a change in the attribute of a node data structure in the plurality of node data structures further cause at least one of the one or more processors to:
receive an update corresponding to the node data structure from a model configured to compute the attribute for a content item corresponding to the node data structure, the update being received via a webhook Application Programming Interface (API).

10. The apparatus of claim 8, wherein each receiver delta value for each receiver node is determined as a dot product of the transmitter delta value and a similarity value embedded in a neighbor pointer linking the transmitter node to that receiver node.

11. The apparatus of claim 8, wherein at least one of the one or more memories has further instructions stored thereon that, when executed by at least one of the one or more processors, cause at least one of the one or more processors to:
maintain a propagation cache configured to store a list of all node data structures visited during a propagation event corresponding to a change in an attribute.

12. The apparatus of claim 11, wherein each iteration in the one or more iterations further comprises:
determining whether a receiver node in the one or more receiver nodes is in the propagation cache; and
removing the receiver node from the one or more receiver nodes based at least in part on a determination that the receiver node is in the propagation cache.

13. The apparatus of claim 8, wherein the at least one termination condition comprises one or more of:
a predetermined time period passing since detection of the change in the attribute of the node data structure;
a predetermined quantity of iterations being performed;
the transmitter delta value falling below a predetermined threshold; or
a determination that there are no receiver nodes directly connected to the transmitter node.

14. The apparatus of claim 8, wherein at least one of the one or more memories has further instructions stored thereon that, when executed by at least one of the one or more processors, cause at least one of the one or more processors to:
determine whether a predetermined time period has passed since a change in a delta value of a second node data structure in the plurality of node data structures; and
remove the second node data structure from the connected graph based at least in part on a determination that the predetermined time period has passed since a change in the delta value of the second node data structure.

15. At least one non-transitory computer-readable medium storing computer-readable instructions for attribute propagation that, when executed by one or more computing devices, cause at least one of the one or more computing devices to:
store a connected graph comprising a plurality of node data structures corresponding to a plurality of content items, each node data structure comprising an identifier, a plurality of neighbor pointers linking to a plurality of neighbor node data structures, and a delta value corresponding to a change in an attribute of a corresponding content item, wherein each neighbor pointer embeds a similarity value between a content item corresponding to the node data structure and a neighbor content item corresponding to the neighbor node data structure linked by the neighbor pointer;
detect a change in the attribute of a node data structure in the plurality of node data structures, the change in the attribute being represented by a delta value of the node data structure;
designate the node data structure as a transmitter node; and
propagate the change in the attribute of the node data structure to connected node data structures in the connected graph, wherein propagating the change in the attribute comprises performing one or more iterations of:
identifying one or more receiver nodes directly connected to the transmitter node, the one or more receiver nodes corresponding to one or more one node data structures linked to the transmitter node via one or more neighbor pointers of the transmitter node;
determining one or more receiver delta values for the one or more receiver nodes based at least in part on a transmitter delta value of the transmitter node and one or more similarity values embedded in the one or more neighbor pointers; and
performing a subsequent iteration of the one or more iterations for each receiver node in the one or more receiver nodes based at least in part on a determination that at least one termination condition is not met, wherein the subsequent iteration designates the receiver node as the transmitter node.

16. The at least one non-transitory computer-readable medium of claim 15, wherein the instructions that, when executed by at least one of the one or more computing devices, cause at least one of the one or more computing devices to detect a change in the attribute of a node data structure in the plurality of node data structures further cause at least one of the one or more computing devices to:
receive an update corresponding to the node data structure from a model configured to compute the attribute for a content item corresponding to the node data structure, the update being received via a webhook Application Programming Interface (API).

17. The at least one non-transitory computer-readable medium of claim 15, wherein each receiver delta value for each receiver node is determined as a dot product of the transmitter delta value and a similarity value embedded in a neighbor pointer linking the transmitter node to that receiver node.

18. The at least one non-transitory computer-readable medium of claim 15, further storing computer-readable instructions that, when executed by one or more computing devices, cause at least one of the one or more computing devices to:
maintain a propagation cache configured to store a list of all node data structures visited during a propagation event corresponding to a change in an attribute.

19. The at least one non-transitory computer-readable medium of claim 18, wherein each iteration in the one or more iterations further comprises:
determining whether a receiver node in the one or more receiver nodes is in the propagation cache; and
removing the receiver node from the one or more receiver nodes based at least in part on a determination that the receiver node is in the propagation cache.

20. The at least one non-transitory computer-readable medium of claim 15, wherein the at least one termination condition comprises one or more of:
a predetermined time period passing since detection of the change in the attribute of the node data structure;
a predetermined quantity of iterations being performed;
the transmitter delta value falling below a predetermined threshold; or
a determination that there are no receiver nodes directly connected to the transmitter node.

21. The at least one non-transitory computer-readable medium of claim 15, further storing computer-readable instructions that, when executed by one or more computing devices, cause at least one of the one or more computing devices to:
determine whether a predetermined time period has passed since a change in a delta value of a second node data structure in the plurality of node data structures; and
remove the second node data structure from the connected graph based at least in part on a determination that the predetermined time period has passed since a change in the delta value of the second node data structure.
